(19) United States
(12) Patent Application Publication
(10) Pub. No.: US 2007/0002709 A1
(43) Pub. Date: Jan. 4, 2007

(54) Detection method and control method for rotational speed of disk replaying apparatus, and disk replaying apparatus

(75) Inventor: Toshio Nishino, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/455,206

(22) Filed: Jun. 19, 2006

(30) Foreign Application Priority Data
Jun. 21, 2005 (JP) 2005-180255

(51) Int. Cl. G11B 27/36

(52) U.S. Cl. 369/53.3

(57) ABSTRACT

A disk replaying apparatus operates such that the polarity of an FA control signal is serially extracted, and a cycle T is extracted from the polarity. When a reciprocal (1/T) of the cycle T is within a “desired-rotational-speed×0.8<1/T<desired-rotational-speed×1.2” range, the reciprocal (1/T) of the cycle T is set to the rotational speed, or otherwise a cycle T is selected again. This operation is attributed to the fact a disk fixed in place is not completely parallel to the absolute position of an objective lens, such that an FE signal corresponding to the rotation of the disk can be extracted, and an FA control signal responsive thereto can be obtained. Thereby, the disk replaying apparatus exhibits high responsivity over the rotational speed control, and is realizable at low costs.

The present application is based on and claims priority of Japanese patent application No. 2005-180255 filed on Jun. 21, 2005, the entire contents of which are hereby incorporated by reference.

### BACKGROUND OF THE INVENTION

1. Field of the Invention

The present invention relates to a detection method and a control method for the rotational speed of a spindle motor used in a disk replaying apparatus.

2. Description of the Related Art

When reading data recorded on a predetermined portion of a disk in the disk replaying apparatus, an OPU (optical pickup unit) is first moved in accordance with the amount of movement calculated from the logical address of that portion. Then, the rotational speed of the disk is controlled to phase lock the OPU to a signal corresponding to the predetermined portion, thereby to read the data. Known control methods for the rotational speed include, for example, a method as disclosed in Japanese Unexamined Patent Application Publication No. 2002-170262 (which hereinbelow will be referred to as “conventional technique 1”) that provides control by directly monitoring the rotational speed of a spindle motor. A known method of another type controls the rotational speed by verifying whether a phase lock loop (PLL) has been able to achieve the so-called “pull-in” operation (the method hereafter will be referred to as a “conventional technique 2”).

FIG. 11 shows the configuration of a disk replaying apparatus according to the conventional technique 1, and FIGS. 12 and 13 shows a procedure of rotational speed control for the apparatus. The rotational speed is obtained by monitoring, for example, an output signal of a sensor mounted to the spindle motor or a driving pulse for the spindle motor (in the case of a blushless type). Thereby, the driving voltage or pulse is controlled so that the rotational speed becomes a predetermined one acceptable for a PLL of a DRC (digital read channel) to achieve the pull-in operation.

FIG. 1 shows the configuration of a disk replaying apparatus according to the conventional technique 2, and FIG. 14 shows a control procedure for the rotational speed thereof. A spindle motor driving signal predetermined in the apparatus and corresponding to a predetermined logical address is applied, and then micro-adjustment (slight increase or decrease) is iteratively carried out until a signal acceptable for the pull-in operation of the PLL can be extracted.

However, these rotational speed control methods have problems. In the case of the conventional technique 1, since the rotational speed of the spindle motor can be directly controlled, there are no problems with the responsivity. However, a problem arises in that costs are increased by the provision of a necessary sensor (shown at 13 of FIG. 11) dedicated for monitoring the rotational speed. In the case of the conventional technique 2, since a sensor for monitoring the spindle motor rotational speed, such as described above, is not necessary, the costs are relatively low. However, a problem arises in that the rotational speed cannot be directly controlled, and even data read has to be done, so that it takes time for the data read, consequently diminishing the responsivity.

### SUMMARY OF THE INVENTION

The present invention is made in view of the problems described above, and accordingly, an object of the invention is to provide a disk replaying apparatus that exhibits high responsivity over control of the rotational speed of a spindle motor and that is realizable at low costs.

According to a first aspect of the present invention, a detection method for a rotational speed of a disk replaying apparatus includes a spindle motor for rotationally driving a disk medium; a pickup for irradiating laser light onto a predetermined position of the disk and receiving reflected light from therefrom, thereby to detect data stored in the disk medium; and a focus actuator (or, “FA,” hereinafter) for moving the pickup along a focus direction in accordance with the reflected light, in which the disk replaying apparatus either reproduces information recorded in an arbitrary position of the disk medium or records information in an arbitrary position. The detection method comprises extracting a cycle of a control signal (or, “FA control signal,” hereinafter) issued from the focus actuator in accordance with reflected light of the laser light from the disk medium; and calculating the rotational speed of the spindle motor from the extracted cycle.

In one example of the detection method for a rotational speed of a disk replaying apparatus according to the first aspect, the rotational speed of the spindle motor can be detected without providing a sensor dedicated for detecting the rotational speed.

In the one example of the detection method for a rotational speed of a disk replaying apparatus according to the first aspect, in the step of extracting the cycle of the FA control signal, a polarity of the FA control signal generated from a focus error signal (FE signal) associated with deflection of a surface of the disk medium is serially stored, and a cycle of inversion of the stored polarity is extracted.

In the one example of the detection method for a rotational speed of a disk replaying apparatus, the rotational speed of the spindle motor can be detected without providing a sensor dedicated for detecting the rotational speed.

According to a second aspect of the present invention, a control method for a rotational speed of a disk replaying apparatus uses the detection method for a rotational speed of a disk replaying apparatus according to the first aspect or the one example thereof, in which the control method controls the rotational speed of the spindle motor in accordance with the result of a comparison between the rotational speed detected by the detection method and a desired rotational speed.

In the control method for a rotational speed of a disk replaying apparatus according to the second aspect, the rotational speed of the spindle motor can be detected, and the rotational speed control can be performed by using the rotational speed, without providing a sensor dedicated for detecting the rotational speed.

According to a third aspect of the present invention, a disk replaying apparatus uses the detection method for a rotational speed of a disk replaying apparatus, as described in the first aspect or the one example thereof, in which the disk replaying apparatus detects the rotational speed of the spindle motor.

In the disk replaying apparatus according to the third aspect, a sensor dedicated for detecting the rotational speed of the spindle motor becomes unnecessary.

According to a fourth aspect of the present invention, a disk replaying apparatus uses the detection method for a rotational speed of a disk replaying apparatus as described in the first aspect or the one example thereof, in which the disk replaying apparatus controls the rotational speed of the spindle motor in accordance with the result of a comparison between the rotational speed, which has been detected by the detection method for a rotational speed of a disk replaying apparatus according to the first aspect or the one example thereof, and a desired rotational speed.

In the disk replaying apparatus according to the fourth aspect, a sensor dedicated for detecting the rotational speed of the spindle motor becomes unnecessary.

According to the aspects of the present invention, the rotational speed of the spindle motor is detected and the control is provided by using the detected rotational speed, such that high responsivity is obtained. Further, since no sensor is necessary to detect the rotational speed of the spindle motor, the cost can be reduced. Consequently, the present invention makes it possible to provide the disk replaying apparatus that exhibits high responsivity over control of the rotational speed of the spindle motor and that is realizable at low costs.

### BRIEF DESCRIPTION OF THE DRAWINGS

In the accompanying drawings,

FIG. 1 is a block diagram showing the configuration of a disk replaying apparatus that will be referred to in conjunction with first and second embodiments of the present invention and the conventional technique 2;

FIGS. 2A to 2C, respectively, show signals in the first and second embodiments;

FIG. 3 is a flowchart showing a procedure of rotational speed control in the first embodiment;

FIG. 4 is a continued flowchart showing the procedure of the rotational speed control in the first embodiment;

FIG. 5 is a flowchart showing a procedure of rotational speed detection in the first embodiment;

FIG. 6 is a continued flowchart showing the procedure of the rotational speed detection in the first embodiment;

FIG. 7 is a flowchart showing a procedure of rotational speed control in the second embodiment;

FIG. 8 is a continued flowchart showing the procedure of the rotational speed control in the second embodiment;

FIG. 9 is a flowchart showing a procedure of rotational speed detection in the second embodiment;

FIG. 10 is a continue flowchart showing the procedure of the rotational speed detection in the second embodiment;

FIG. 11 is a block diagram showing the configuration of a disk replaying apparatus according to the conventional technique 1;

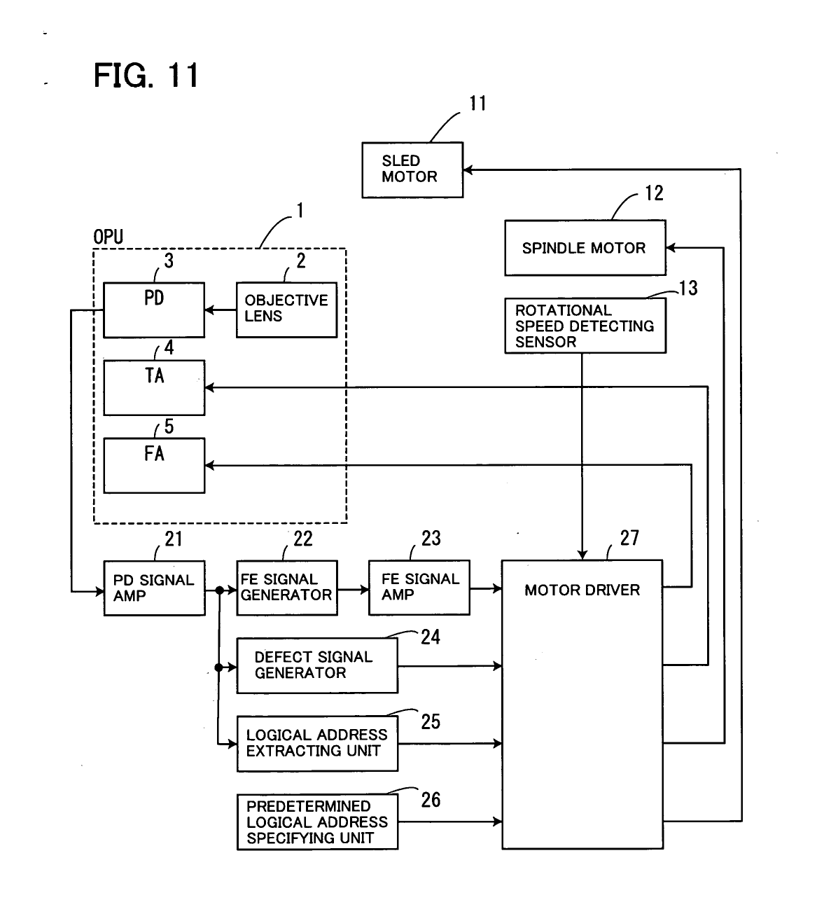

FIG. 12 is a flowchart showing a procedure of rotational speed control in the conventional technique 1;

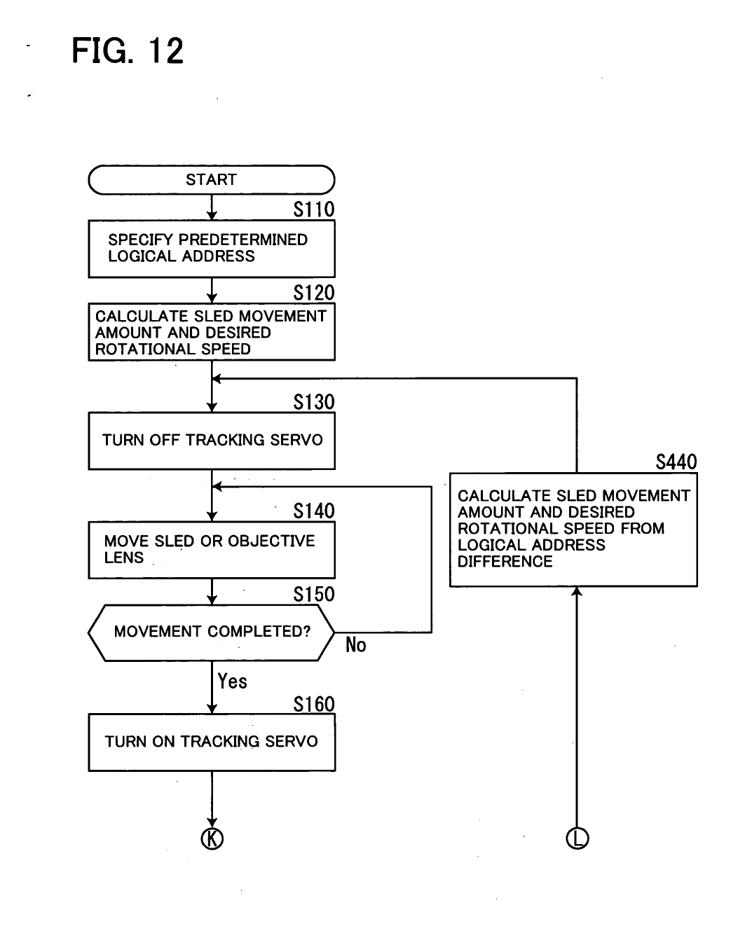

FIG. 13 is a continued flowchart showing the procedure of the rotational speed control in the conventional technique 1; and

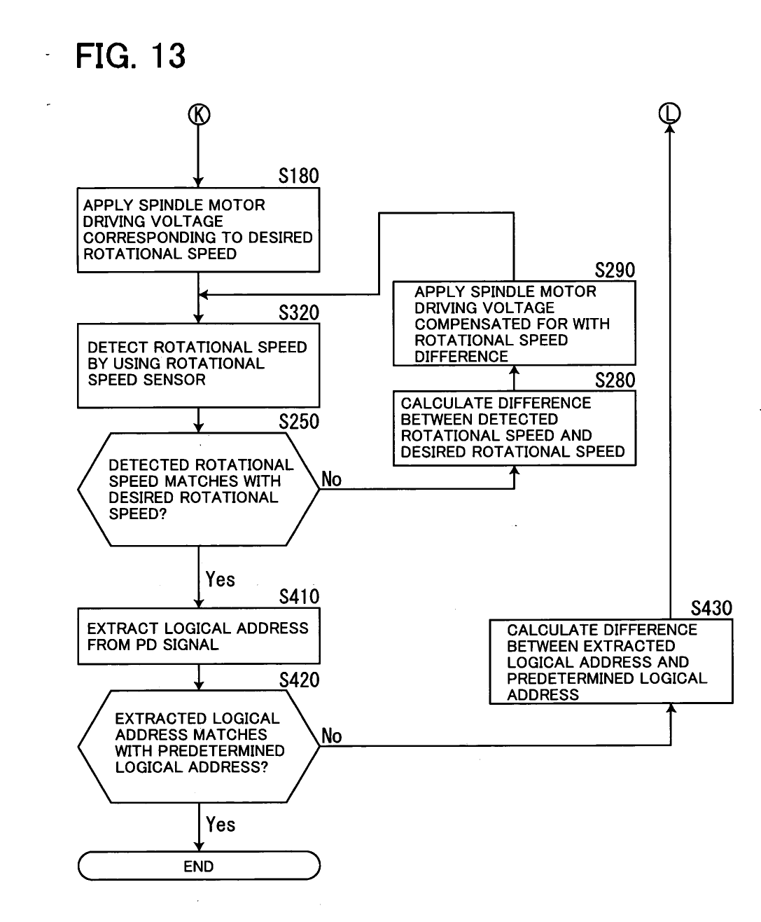

FIG. 14 is a flowchart of a procedure of rotational speed control in the conventional technique 2.

### DETAILED DESCRIPTION OF THE PREFERRED EMBODIMENTS

Embodiments of the present invention will be described below with reference to the drawings.

### First Embodiment

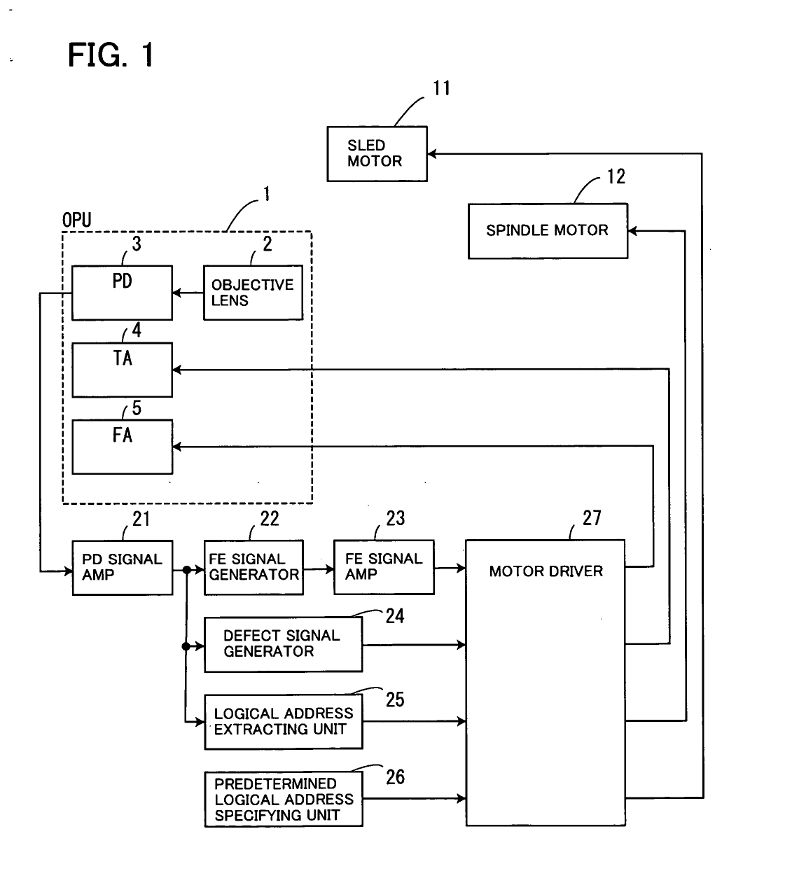

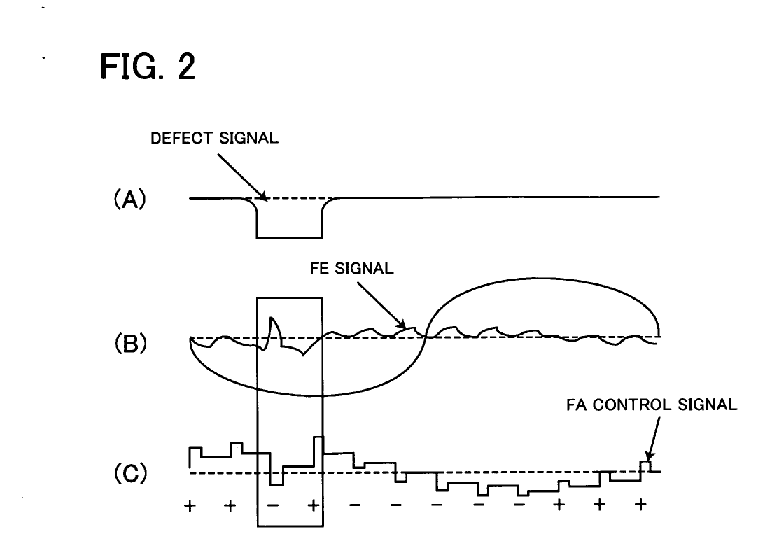

FIG. 1 is a block diagram showing the configuration of a disk replaying apparatus employing one embodiment of the present invention. The block diagram shown in FIG. 1 has the configuration substantially the same as that of the disk replaying apparatus described in conjunction with the conventional technique 2. FIGS. 2A to 2C, respectively, show signals in the disk replaying apparatus. Light reflected off of a disk is collected or focused by an objective lens 2, then is converted by a photodetector 3 (“PD,” hereafter) to an electric signal (“PD signal,” hereafter), and then is input into a PD signal amp 21 (amp=amplifier). An optical pickup 1 (“OPU,” hereafter) includes the objective lens 2, the PD 3, a tracking actuator 4 (“TA,” hereafter) for performing tracking, and a focus actuator 5 (“FA,” hereafter) for registration of the focal point of the objective lens 2. A sled (not shown) on which the above-described components are mounted can be moved by a sled motor 11 along the radial direction of the disk.

A signal input into the PD signal amp 21 is amplified therein, and then input into an FE (focus error) signal generator 22, a defect signal generator 24, and a logical address extracting unit 25.

An FE signal is generated from the amplified PD signal in the FE signal generator 22 and amplified in an FE signal amp 23. FIG. 2B shows the FE signal (output of the FE signal generator 22). The defect signal generator 24 generates a defect signal from the amplified PD signal. FIG. 2A shows the defect signal (output of the defect signal generator 24). The logical address extracting unit 25 extracts from the amplified PD signal logical address of a sector actually being read.

A predetermined logical address specifying unit 26 specifies a logical address of a sector that will be read. A motor driver 27 outputs respective control signals for controlling the TA 4, the FA 5, the sled motor 11, and a spindle motor 12 in accordance with inputs from the FE signal amp 23, the defect signal generator 24, the logical address extracting unit 25, and the predetermined logical address specifying unit 26. FIG. 2C shows a control signal (FA control signal) that is input into the FA.

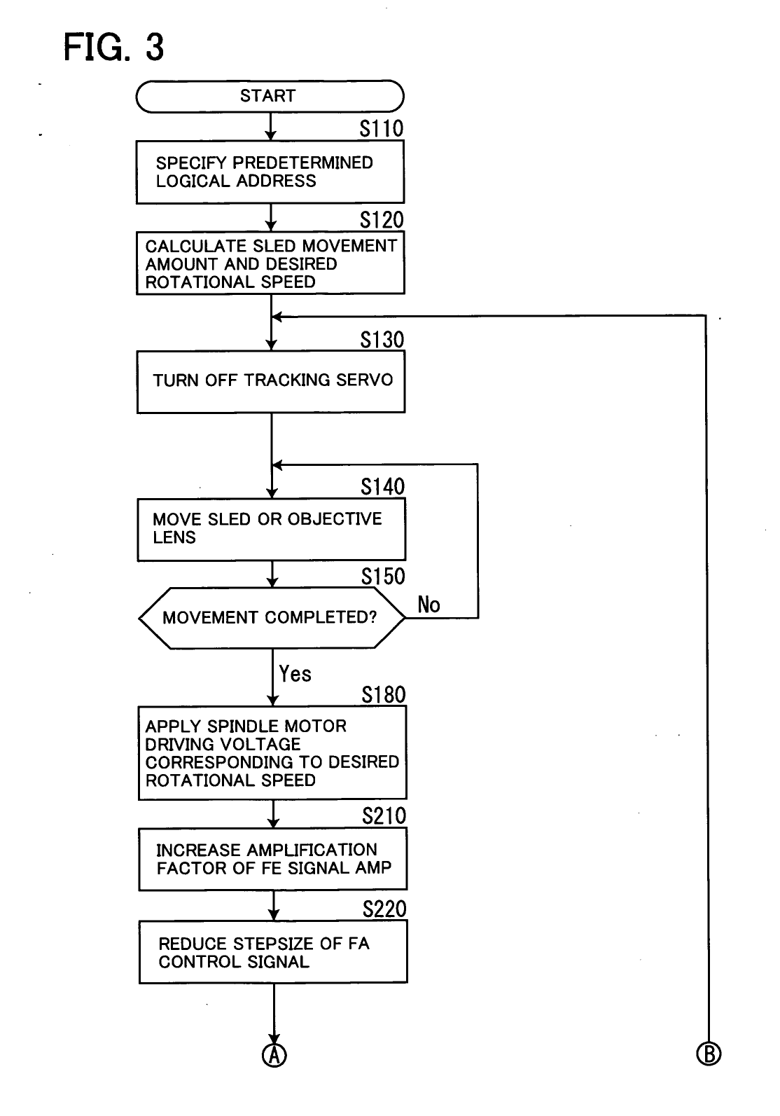

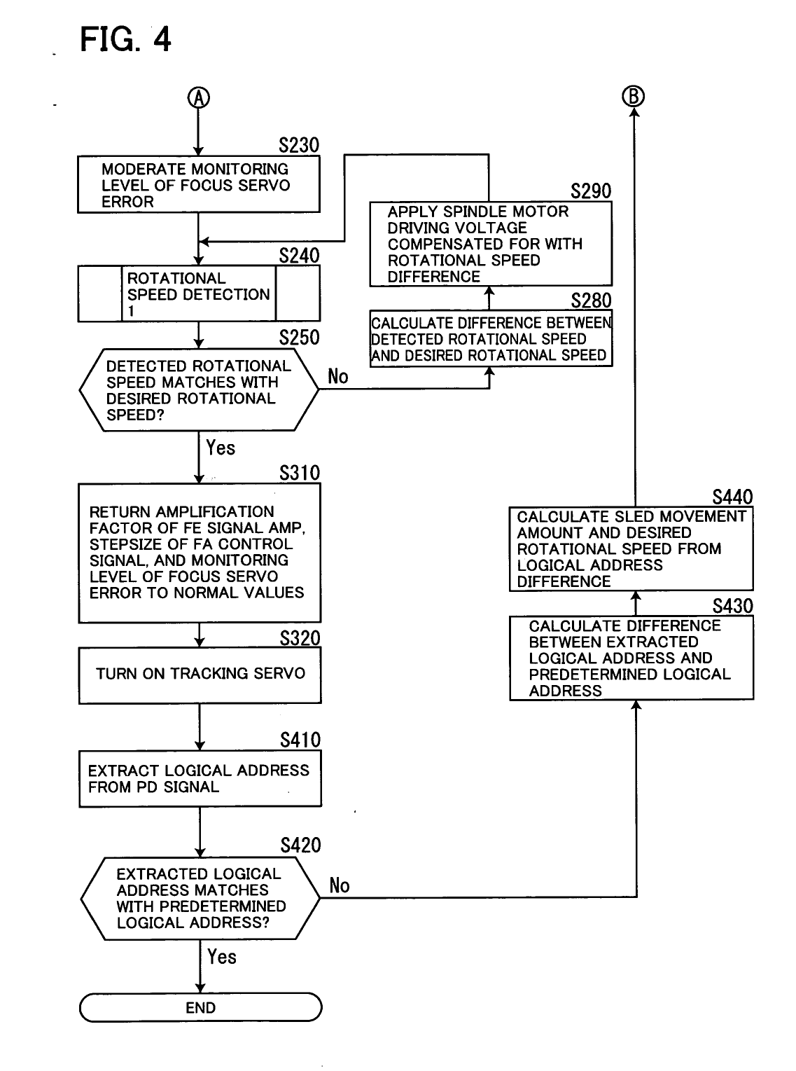

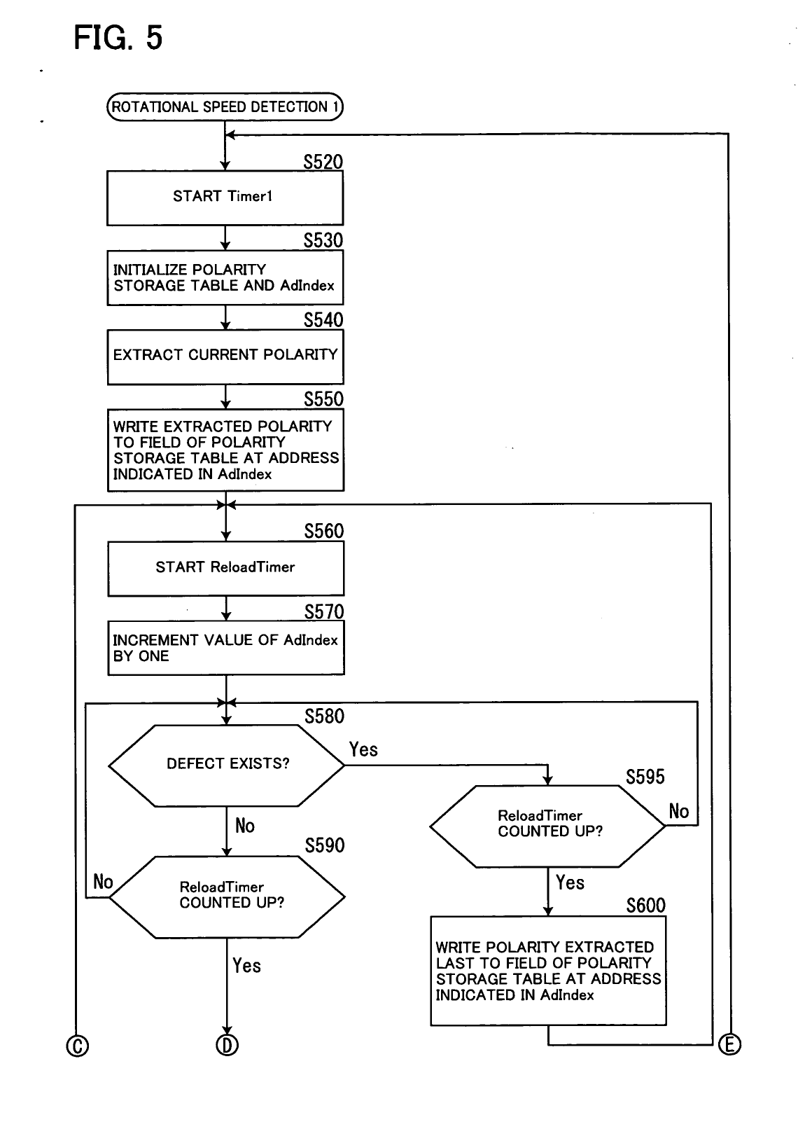

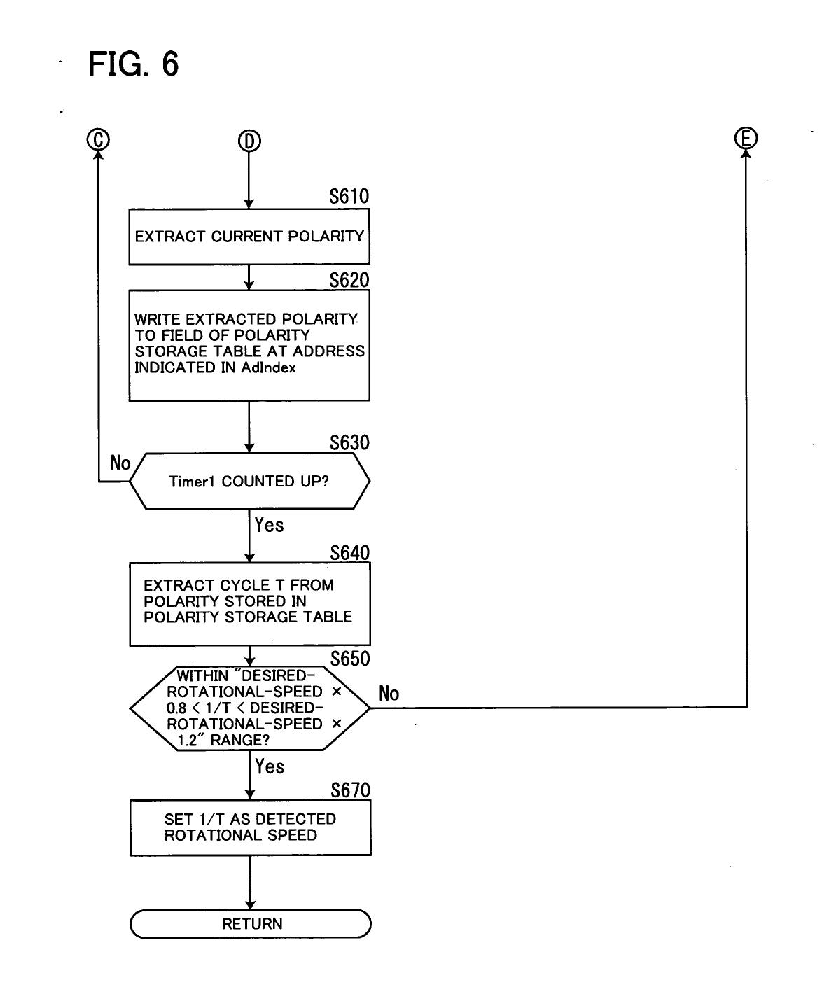

A procedure of rotational speed control in the disk replaying apparatus thus configured will be described herebelow. FIGS. 3 and 4 show a flowchart showing the overall procedure of the rotational speed control. FIGS. 5 and 6 depict a flowchart showing detail of a rotational speed detection process (step S240 described below).

First, the procedure will be described herebelow with reference to FIGS. 3 and 4. At step S110 a logical address of a sector to be read (or, a “read sector,” hereafter) is specified. At step S120 calculations are performed to obtain the amount of movement of the sled corresponding to the logical address and a desired rotational speed of the spindle motor 12 at the position corresponding thereto. At step S130 a tracking servo is turned off. At subsequent step S140 the sled is moved by the sled motor 11, or the objective lens 2 is moved by the FA 5. Then at step S150 it is determined whether the movement at the movement step S140 has been completed. If the movement has been completed, then the process proceeds to step S180 or otherwise to step S140.

At step S180 the motor driver 27 provides control such that a driving voltage for the spindle motor 12, which voltage corresponds to the calculated desired rotational speed, is applied.

At step S210 the amplification factor of the FE signal amp 23 is increased. Then at step S220 a stepsize of an FA control signal is (one stepsize of the output of a D/A converter) is reduced (this enables obtaining an FA control signal larger in the amount of variation, compared to the actual amount of movement of the objective lens 2 during the normal operation). At subsequent step S230 a monitoring level of focus servo error is moderated (thereby to circumvent a process interrupt during the movement of the sled).

At the subsequent step S240 the process detects the rotational speed of the spindle motor 12, and then proceeds to step S250 (the rotational speed detection will be described further below with reference to FIGS. 5 and 6).

At step S250 it is determined whether the rotational speed detected at step S240 matches with the desired rotational speed. If the detected rotational speed matches with the desired rotational speed, the process proceeds to step S310 or otherwise to step S280. A difference between the detected rotational speed and the desired rotational speed is calculated at step S280, and the driving voltage for the spindle motor 12, which voltage has been compensated for with the calculated difference, is applied at step S290. Then, the process proceeds to step S240.

At step S310 the amplification factor of the FE signal amp 23, the stepsize of the FA control signal, and the monitoring level for the focus servo error, respectively, are returned to normal values. Then, the tracking servo is turned on at step S320, and a logical address is extracted from the PD signal at step S410. At subsequent step S420 it is determined whether the extracted address matches with the predetermined logical address, in which if a match is found, the process proceeds to “End” or otherwise to step S430.

At step S430 a difference between the logical address extracted at step S410 and the predetermined logical address is calculated, and at step S440 the amount of movement of the sled and a desired rotational speed is calculated from the difference. Then the process proceeds to step S130.

The following describes a detection process of the rotational speed of the spindle motor 12, which is shown in FIGS. 5 and 6 (the process corresponds to step S240 in FIG. 4). With reference to FIGS. 5 and 6, “ReloadTimer” represents a timer for generating the timings of writing the polarities of FA control signals into a polarity storage table. “Timer1” represents a timer for generating the timings of extracting a rotational cycle T of the spindle motor 12 by searching the polarity storage table. “AdIndex” is a variable representing a write address at which a write is to be performed into the polarity storage table.

At step S520 Timer1 is started, and at step S530 the polarity storage table, which is used to store the polarities of FA control signals, and AdIndex are initialized. At subsequent step S540 a present or current FA control signal is extracted, and at step S550 the extracted polarity is written into a field of the polarity storage table at an address indicated in AdIndex.

At subsequent step S560 ReloadTimer is started, and at step S570 the value of AdIndex is incremented by one.

At subsequent step S580 it is determined whether a defect exists. If a defect exists, the process proceeds to step S595 or otherwise to step S590.

At step S595 it is determined whether ReloadTimer has counted up. If counted up, then the process proceeds to step S600 or otherwise to step S580. At step S600 the polarity of an FA control signal received last is written to a field of the polarity storage table at an address shown in AdIndex, and then the process proceeds to step S560.

At step S590 it is determined whether ReloadTimer has counted up. If counted up, then the process proceeds to step S610 or otherwise to step S580. At step S610 the polarity of a current FA control signal is extracted, and at step S620 the polarity is written to a field of the polarity storage table at an address indicated in AdIndex. Then, the process proceeds to step S630.

At step S630 it is determined whether Timer1 has counted up. If counted up, the process proceeds to step S640 or otherwise to step S560.

At step S640 the rotational cycle T is extracted from the polarity stored in the polarity storage table. The disk fixed in place is not completely parallel to the absolute position of the objective lens 2, such that an FE signal corresponding to the rotation of the disk can be extracted (see FIG. 2B), and an FA control signal responsive thereto can be obtained (see FIG. 2C). The cycle T is calculated from alteration in the polarity of the FA control signal, and the rotational speed is obtained. In a defect period (portion in a rectangle shown across FIGS. 2B and 2C), the polarity alteration is not monitored. More specifically, in an example shown in FIG. 2C, the polarity is not recognized as “−, +,” but is recognized as “t+, +” to permit continuation of the previous polarity.

At subsequent step S650, in the event that the reciprocal (1/T) of the extracted cycle T is greater than 0.8 times the desired rotational speed and less than 1.2 times the desired rotational speed, the process proceeds to step S670 or otherwise to step S520.

At step S670 the detected value 1/T is set to the rotational speed, and then the process proceeds to “Return” (returns to the main routine shown in FIG. 4).

### Second Embodiment

A second embodiment is carried out in a disk replaying apparatus similar to the disk replaying apparatus according to the first embodiment (shown in FIG. 1). Description of the configuration of the apparatus will be omitted herefrom.

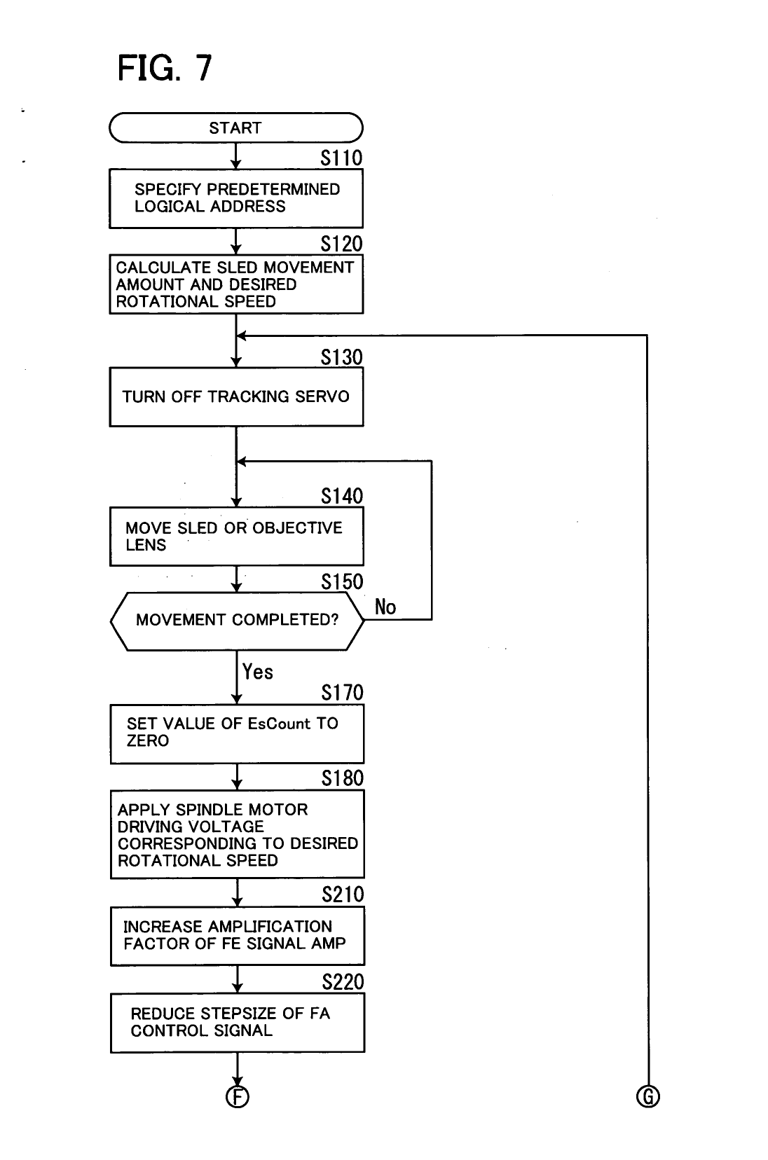

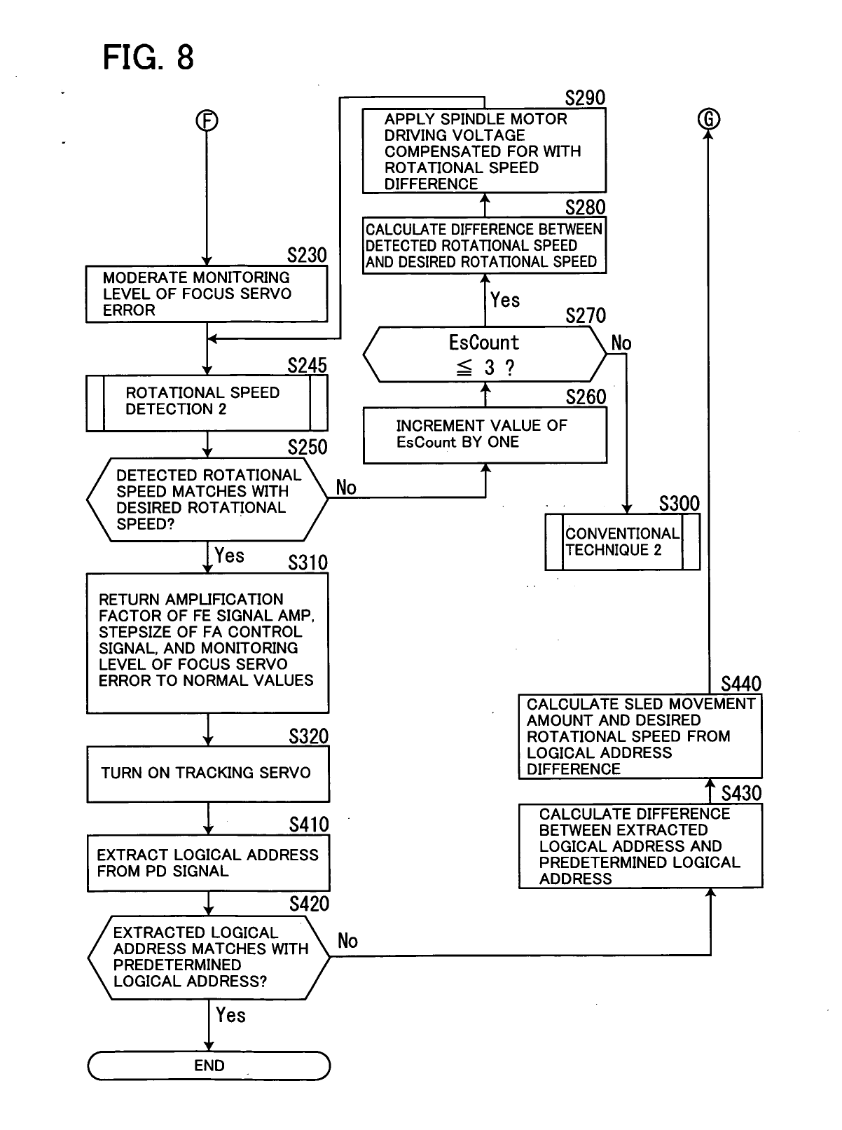

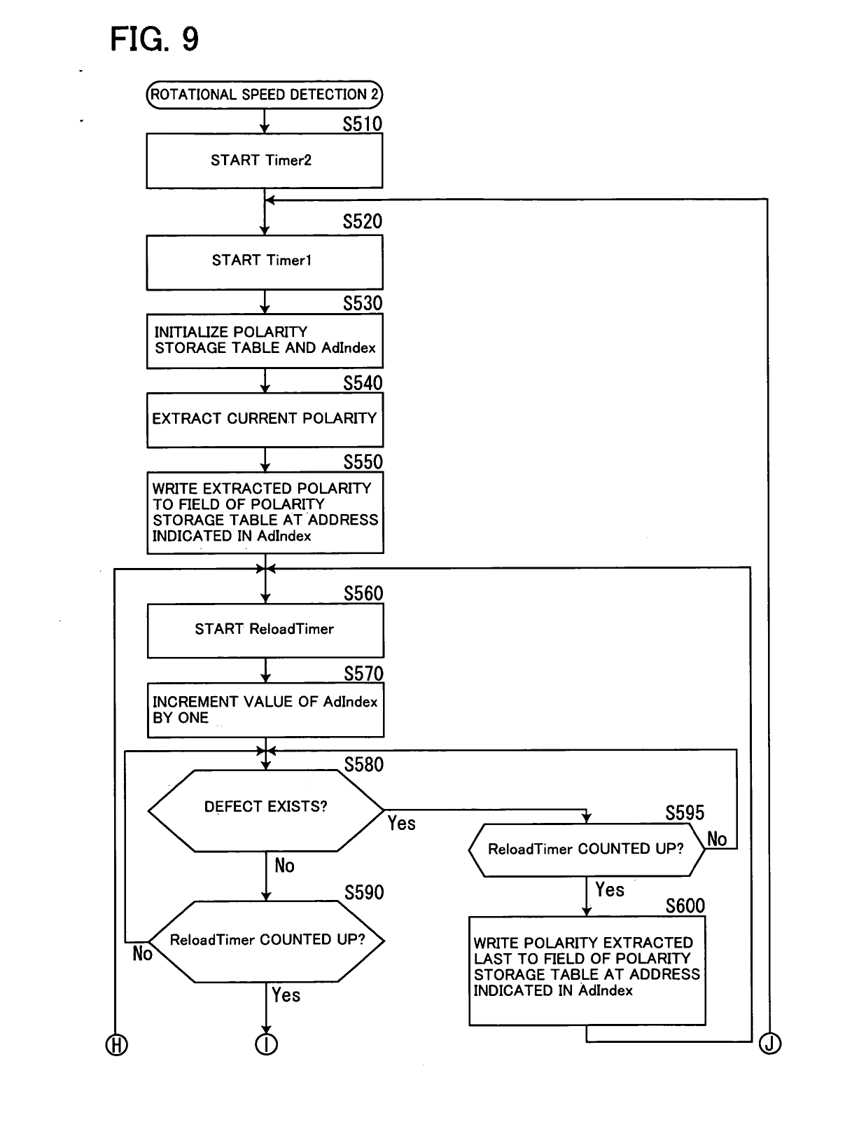

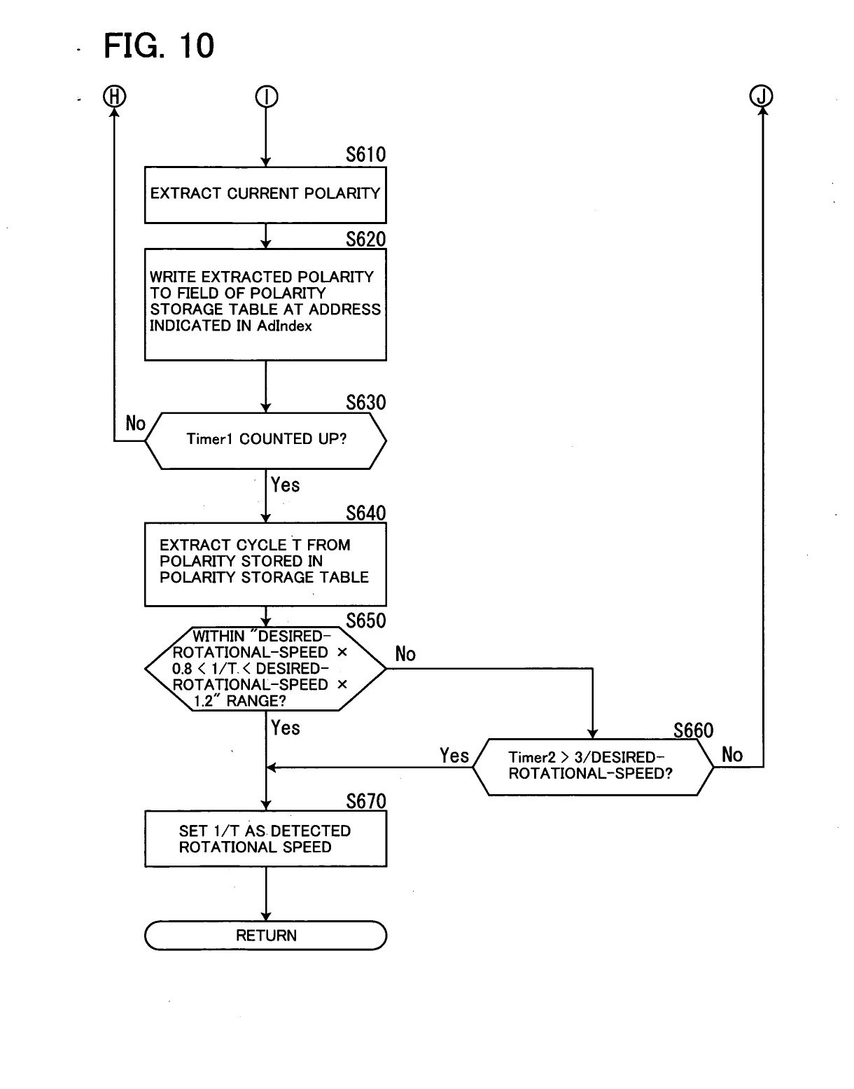

FIGS. 7 and 8 are a flowchart showing the overall procedure of the rotational speed control. FIGS. 9 and 10 are a flowchart showing detail of a rotational speed detection process (step S245) shown in FIG. 8.

First, the procedure will be described with reference to FIGS. 7 and 8. “EsCount” is a variable for counting the number of detections of the rotational speed of the spindle motor 12. At step S110 a logical address of a read sector is specified, and at step S120 calculations are performed to obtain the amount of movement of the sled corresponding to the logical address and a desired rotational speed of the spindle motor 12 at the position corresponding thereto. At step S130 a tracking servo is turned off. At subsequent step S140, the sled is moved by the sled motor 11, or the objective lens 2 is moved by the FA 5. Then, at step S150, it is determined whether the movement at the movement step S140 has been completed. If the movement has been completed, then the process proceeds to step S170 or otherwise to step S140.

At step S170 the value of EsCount is set to zero (0), and at step S180 the motor driver 27 provides control such that a driving voltage for the spindle motor 12, which voltage corresponds to the calculated desired rotational speed, is applied.

At step S210 the amplification factor of the FE signal amp 23 is increased. Then at step S220 a stepsize of an FA control signal (one stepsize of the output of a D/A converter) is reduced (this enables obtaining an FA control signal larger in the amount of variation, compared to the actual amount of movement of the objective lens 2 during the normal operation). At subsequent step S230, the monitoring level of focus servo error is moderated (thereby to circumvent a process interrupt during the movement of the sled).

At the subsequent step S245 the process detects the rotational speed of the spindle motor 12, and then proceeds to step S250 (the rotational speed detection will be described further below with reference to FIGS. 9 and 10).

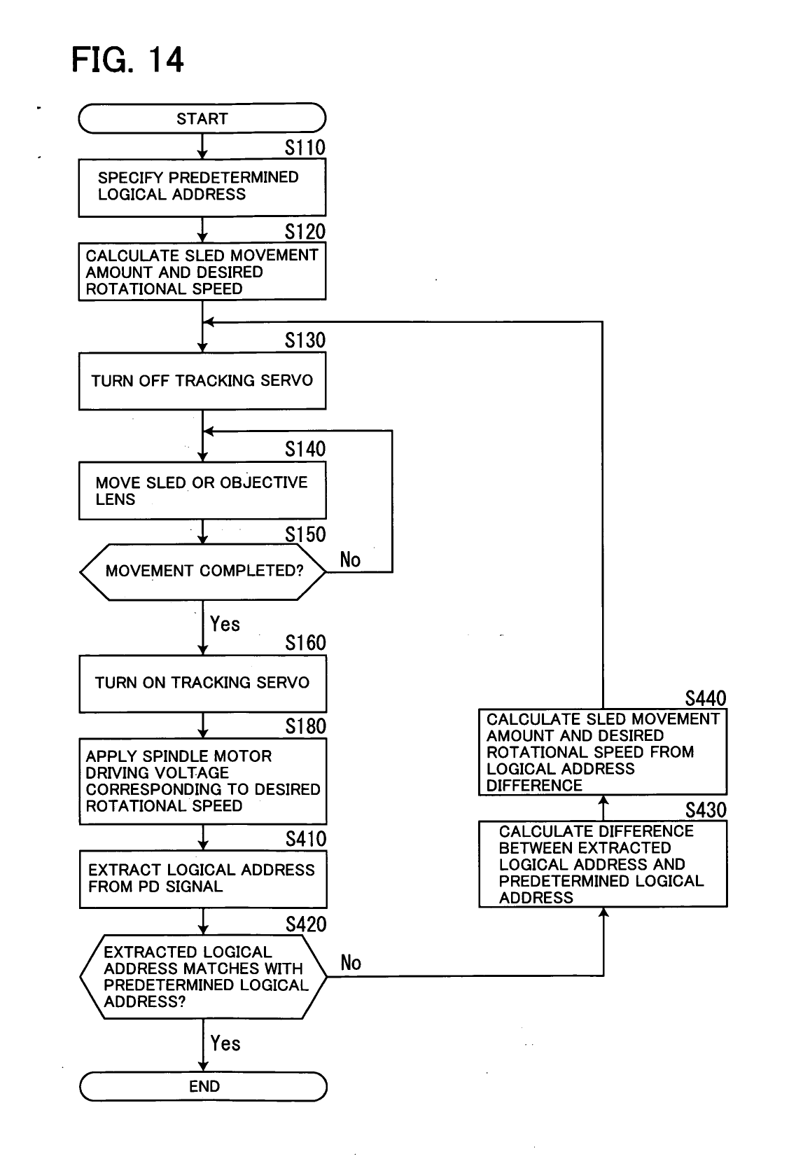

At step S250 it is determined whether the rotational speed detected at step S245 matches with the desired rotational speed. If the detected rotational speed matches with the desired rotational speed, the process proceeds to step S310 or otherwise to step S260. At step S260 the value of EsCount is incremented by one, at step S270 it is determined whether the value of EsCount is 3 or less. If the value is 3 or less, then the process proceeds to S280 or otherwise to step S300. At step S300 the process of rotational speed control is performed by the method in accordance with the conventional technique 2 (method shown in FIG. 14). A difference between the detected rotational speed and the desired rotational speed is calculated at step S280, and the driving voltage for the spindle motor 12, which voltage has been compensated for with the calculated difference, is applied at step S290. Then, the process proceeds to step S245.

At step S310 the amplification factor of the FE signal amp 23, the step size of the FA control signal, and the monitoring level for the focus servo error, respectively, are returned to normal values. Then, the tracking servo is turned on at step S320, and a logical address is extracted from the PD signal at step S410. At subsequent step S420 it is determined whether the extracted address matches with the predetermined logical address, in which if a match is found, the process proceeds to “End” or otherwise to step S430.

At step S430 a difference between the logical address extracted at step S410 and the predetermined logical address is calculated, and at step S440 an amount of movement of the sled and a desired rotational speed is calculated from the difference. Then, the process proceeds to step S130.

The following describes a detection process of the rotational speed of the spindle motor 12, which is shown in FIGS. 9 and 10 (the process corresponds to step S245 in FIG. 8). With reference to FIGS. 9 and 10, “ReloadTimer” is the timer for generating the timings of writing the polarities of FA control signals into the polarity storage table. “Timer1” is the timer for generating the timings of extracting the rotational cycle T of the spindle motor 12 by searching the polarity storage table. “Timer2” is a timer for measuring a wait time before reaching the range of ±20% of the desired rotational speed. “AdIndex” is the variable representing a write address at which a write is to be performed into the polarity storage table.

At step S510 Timer2 is started, and at step S520 Timer1 is started. Then at step S530 the polarity storage table, which is used to store the polarities of FA control signals, and AdIndex are initialized. At subsequent step S540 a current FA control signal is extracted, and at step S550 the extracted polarity is written to a field of the polarity storage table at an address indicated in AdIndex.

At subsequent step S560 ReloadTimer is started, and at step S570 the value of AdIndex is incremented by one.

At subsequent step S580 it is determined whether a defect exists. If a defect exists, the process proceeds to step S595 or otherwise to step S590.

At step S595 it is determined whether ReloadTimer has counted up. If counted up, then the process proceeds to step S600 or otherwise to step S580. At step S600 the polarity of an FA control signal received last is written to a field of the polarity storage table at an address shown in AdIndex, and then the process proceeds to step S560.

At step S590 it is determined whether ReloadTimer has counted up. If counted up, then the process proceeds to step S610 or otherwise to step S580. At step S610 the polarity of a current FA control signal is extracted, and at step S620 the polarity is written to a field of the polarity storage table at an address indicated in AdIndex. Then, the process proceeds to step S630.

At step S630 it is determined whether Timer1 has counted up. If counted up, the process proceeds to step S640 or otherwise to step S560.

At step S640 a rotation cycle T is extracted from the polarity stored in the polarity storage table. The disk fixed in place is not completely parallel to the absolute position of the objective lens 2, such that an FE signal corresponding to the rotation of the disk can be extracted (see FIG. 2B), and an FA control signal responsive thereto can be obtained (see FIG. 2C). The cycle T is calculated from alteration in the polarity of the FA control signal, and the rotational speed is obtained. In a defect period (portion in a rectangle shown across FIGS. 2B and 2C), the polarity alteration is not monitored. More specifically, in an example shown in FIG. 2C, the polarity is not recognized as “−, +,” but is recognized as “+, +” to permit continuation of the previous polarity.

At subsequent step S650, in the event that the reciprocal (1/T) of the extracted cycle T is greater than 0.8 times the desired rotational speed and less than 1.2 times the desired rotational speed, the process proceeds to step S670 or otherwise to step S660. At step S660, it is determined whether the value of Timer2 is greater than three times the reciprocal of the desired rotational speed. If the timer value is greater than the reciprocal, the process proceeds to step S670 or otherwise to step S520.

At step S670 the detected value 1/T is set to the rotational speed, then the process proceeds to “Return” (returns to the main routine shown in FIG. 8).

As described above, the present invention enables provision of the disk replaying apparatus that exhibits high responsivity over the rotational speed control of the spindle motor and that is realizable at low costs.

According to the respective embodiment described above, the rotational speed is detected from the inversion cycle of the polarity of the FA control signal. However, the rotational speed can be detected by directly extracting the frequency component of the FA control signal.

The effects of the present invention are as follows.

According to the present invention, the rotational speed of the spindle motor is detected and the control is provided by using the detected rotational speed, such that high responsivity is obtained. Further, since no sensor is necessary to detect the rotational speed of the spindle motor, the cost can be reduced. Consequently, the disk replaying apparatus can be provided that exhibits high responsivity over control of the rotational speed of the spindle motor and that is realizable at low costs.

1. A detection method for a rotational speed of a disk replaying apparatus including a spindle motor for rotationally driving a disk medium; a pickup for irradiating laser light onto a predetermined position of the disk and receiving reflected light from therefrom, thereby to detect data stored in the disk medium; and a focus actuator (or, “FA,” hereinafter) for moving the pickup along a focus direction in accordance with the reflected light, wherein the disk replaying apparatus either reproduces information recorded in an arbitrary position of the disk medium or records information in an arbitrary position, the detection method comprising:
extracting a cycle of a control signal (or, “FA control signal,” hereinafter) issued from the focus actuator in accordance with reflected light of the laser light from the disk medium; and
calculating the rotational speed of the spindle motor from the extracted cycle.

2. The detection method of claim 1, wherein
in the step of extracting the cycle of the FA control signal, a polarity of the FA control signal generated from a focus error signal (FE signal) associated with deflection of a surface of the disk medium is serially stored, and a cycle of inversion of the stored polarity is extracted.

3. A control method for a rotational speed of a disk replaying apparatus, the control method using the detection method for a rotational speed of a disk replaying apparatus according to claim 1, wherein the control method controls the rotational speed of the spindle motor in accordance with the result of a comparison between the rotational speed, which has been detected by the detection method, and a desired rotational speed.

4. A disk replaying apparatus using the detection method for a rotational speed of a disk replaying apparatus according to claim 1, wherein the disk replaying apparatus detects the rotational speed of the spindle motor in accordance with the detection method.

5. A disk replaying apparatus using the detection method for a rotational speed of a disk replaying apparatus according to claim 1, wherein the disk replaying apparatus controls the rotational speed of the spindle motor in accordance with the result of a comparison between the rotational speed, which has been detected by the detection method, and a desired rotational speed.

6. A control method for a rotational speed of a disk replaying apparatus, the control method using the detection method for a rotational speed of a disk replaying apparatus according to claim 2, wherein the control method controls the rotational speed of the spindle motor in accordance with the result of a comparison between the rotational speed, which has been detected by the detection method, and a desired rotational speed.

7. A disk replaying apparatus using the detection method for a rotational speed of a disk replaying apparatus according to claim 2, wherein the disk replaying apparatus detects the rotational speed of the spindle motor in accordance with the detection method.

8. A disk replaying apparatus using the detection method for a rotational speed of a disk replaying apparatus according to claim 2, wherein the disk replaying apparatus controls the rotational speed of the spindle motor in accordance with the result of a comparison between the rotational speed, which has been detected by the detection method, and a desired rotational speed.
